(19) United States
(12) Patent Application Publication
(10) Pub. No.: US 2011/0115916 A1
(43) Pub. Date: May 19, 2011

(54) SYSTEM FOR MOSAIC IMAGE ACQUISITION

(76) Inventor: Eiji Yafuso, Carlsbad, CA (US)

(21) Appl. No.: 12/619,443

(22) Filed: Nov. 16, 2009

(51) Int. Cl. H04N 7/18

(52) U.S. Cl. 348/159; 348/E07.085

(57) ABSTRACT

A mosaic imaging system comprises a support structure, a plurality of individual focal plane arrays secured to the support structure and an afocal primary objective optical element secured to the support structure. Each focal plane array has its own objective optical element secured in relation thereto so that the focal plane array and the objective optical element have a constant spatial relationship, with each objective optical element focusing its respective focal plane array to infinity. The primary objective optical element has an exit pupil subsuming the entrance pupils of the objective optical elements of the focal plane arrays, and is arranged relative to the objective optical elements of the focal plane arrays to maintain throughput and image integrity from object space of the primary objective optical element to each focal plane array. Two or more of the plurality of the individual focal plane arrays may occupy different geometric planes.

### FIELD OF THE INVENTION

The present invention relates to image acquisition, and more particularly to systems for mosaic image acquisition.

### BACKGROUND OF THE INVENTION

In the field of image acquisition, there are a number of known techniques for combining multiple smaller images into a single larger image.

As used herein, the following terms have the following meanings:

“Focal plane array” or “FPA” means a camera element sensitive to optical radiation and which is spatially discrete so as to be capable of forming an image. Such camera elements may include, for example and without limitation, CCD (charge-coupled device) image sensors and CMOS image sensors.
“Integrated objective optic lens” or “InO” means the objective lens used integrated with miniature cameras at chip level to focus an image onto the focal plane array of that camera. Such cameras may include, for example, CCD (charge-coupled device) cameras and CMOS image sensor cameras.
“Afocal” refers to an optical element which does not focus to an image.
“Instantaneous field of view” or “IFOV” refers, in a system which scans, to the field of view of the scan element when not scanning, and, in a system which has multiple sensing sub-elements, the field of view of a particular sub-element.
“Field of regard” or “FOR” refers to the field of view of a larger overall system composed of a plurality of IFOV subsystems.
“Object space” refers to the real world scene being acquired by an imaging system.
“Optical axis” means, for cylindrically symmetric optical elements, the axis of symmetry.
“Image space” refers to the conjugate space of the real world scene after acquisition by an imaging system (i.e. an “image” of the scene).
“Image plane” refers to a conceptually flat plane upon which a 3-D object space scene is projected (one skilled in the art will appreciate that real image planes are rarely flat).
“Stop” refers to a physical surface which allows light to pass but limits the diametric size of any optical ray bundle allowed into an optical system. A stop is generally, but not necessarily, circular.
“Pupil” refers to any image of the stop of an optical system; thus, a stop can also be a pupil in the case where the stop is not viewed through any intervening lenses or mirrors.
“Entrance pupil” refers to the image of the stop of an optical system, viewed from object space.
“Exit pupil” refers to the image of the stop of an optical system, viewed from image space.
“Optical collimation”, and related terms like “collimated” refer to optical rays propagating parallel to each other in 3-D space. In optics this condition is said to be met when rays from an object point arrive from an infinitely distant object. It can thus be synthesized by imaging a point located at the focal point of a lens.
“Ground sample distance” refers to the smallest region of object space which can be resolved by an optical system.

FIG. 1 shows an exemplary broad area surveillance system marketed under the trademark PSiViSiON™ by PV Labs Inc, having an address at McMaster Innovation Park, 175 Longwood Road South, Suite 400A, Hamilton, Ontario, Canada, L8P 0A1. The PSiViSiON surveillance system is denoted generally at 10. The function of the PSIVISION surveillance system 10, and of other broad area surveillance systems, is to acquire broad area video imagery, process the data (possibly into a proprietary format), store the data to long-term memory, and make the imagery available to end-users in both forensic and real-time applications.

Broadly speaking, the exemplary PSiViSiON surveillance system 10 comprises a PSi-POD™ Look Down Gimbal (LDG) 12, which is typically mounted on an aircraft (not shown) to carry out surveillance of a target area. The PSi-POD LDG carries a PSi-SENSOR™ sensor array 14, which includes a suite of high-density image sensors, including visible spectrum and infrared sensors, and is provided with interchangeable optics to provide a customized field of view and resolution ground sample distance. The PSi-SENSOR™ sensor array 14 captures image data and transmits it to a PSiVAULT™ computer system 16 for processing and storage. Access to, and analysis of, the image data 20 is provided using PSi-RECALL™ system interfaces 18, which enables both real-time and forensic analysis.

When carrying out wide area persistent surveillance, it is important to have a wide enough field of regard to encompass the area of interest, while also having sufficient detail (i.e. enough pixels) to support analysis of a particular sub-area of interest (i.e. part of the field of regard). To achieve this, multiple imaging sub-elements are used, and the individual images are combined into a single, larger image, in other words, the individual focal planes of the sub-elements are combined into a large field of regard.

There are two common approaches to combining separate focal planes into one field of regard: the “Scheimpflug” approach and the “bugeye” approach.

With the Scheimpflug approach, focal plane arrays (FPAs) are aligned behind their respective lenses in much the same fashion that they would be combined behind one single lens, were it not for mechanical interferences. Thus, the multiple lenses are aligned and treated as though they were a single pupil through which all FPAs view the infinite conjugate object data. For example, as shown in FIG. 3, two FPAs 310 may be aligned behind a single lens 312, and such a set is then combined with other sets of two (or more) FPAs 310 also behind their own lens 312 to create an apparatus that can generate a mosaic image (optionally, more than two FPAs may also be aligned behind a single lens). More particularly, FIG. 3 shows an exemplary conventional Scheimpflug system configuration comprising eight FPAs 310 behind four lenses 312, with two FPAs 310 behind each lens 312. It should be noted that scaling to more FPAs does not require more lenses. FIG. 2 shows a schematic representation of assembly and processing of a plurality of smaller images 210 into a larger mosaic image 212 according to the Scheimpflug technique, and FIG. 4 shows an exemplary Scheimpflug mosaic image 410 representing a field of regard (FOR).

In the Scheimpflug configuration, each lens 312 must point in the same direction, that is, the optical axes of each of the lenses 312 must be parallel to one another. This requires each FPA 310 behind a given lens 312 to be coplanar with all other FPAs 312 behind that same lens, requiring extremely precise adjustment of the position of each FPA 312 in all six degrees of freedom.

In the bugeye configuration, as in the Scheimpflug configuration, each FPA utilizes its own lens. However, unlike the Scheimpflug configuration, the lenses do not point in the same direction and each FPA stares through that lens' center of projection, creating a mosaic of separate, but overlapping, fields of regard. In this system, the FPAs are not coplanar, but relative alignments between the lenses must be precise in order to generate a useful image. Moreover, the bugeye approach requires one lens for each FPA, making it difficult to scale a bugeye imaging apparatus up to a large number of FPAs in order to generate enough pixels (e.g. to generate a sufficiently detailed image of a large area). FIG. 5 is a schematic representation showing assembly into a mosaic image 510 of a plurality of smaller images 512 originating from a bugeye system (not shown) comprising four FPAs each with its own lens, with each FPA generating a single image 512 that must be combined with the others.

It is also possible to create hybrid systems (i.e. hybrid between Scheimpflug and bugeye) by combining sets of multiple FPAs behind a single lens, with each lens pointing in a different direction and each FPA group staring through its respective lens' center of projection. This simplifies the lens design, but at the cost of dealing with the disadvantages of both approaches.

The current commercial embodiment of the PSiViSiON surveillance system (FIG. 1) uses the Scheimpflug technique to combine the outputs of multiple focal plane arrays to form a larger synthetic focal plane due to commercial unavailability of practical full sized alternatives obtainable from existing manufacturers.

### SUMMARY OF THE INVENTION

In one aspect, the present invention is directed to a mosaic imaging system. The mosaic imaging system comprises a support structure. A plurality of individual focal plane arrays are secured to the support structure. Each focal plane array has its own objective optical element secured in relation thereto so that the focal plane array and the objective optical element have a constant spatial relationship to one another, with the objective optical element focusing the respective focal plane array to infinity. An afocal primary objective optical element is secured to the support structure, with the primary objective optical element having an exit pupil subsuming the entrance pupils of each of the objective optical elements of the focal plane arrays. The primary objective optical element is arranged relative to the objective optical elements of the focal plane arrays to maintain throughput and image integrity from object space of the primary objective optical element to each focal plane array.

In one embodiment, at least two of the individual focal plane arrays occupy different geometric planes.

In a particular embodiment, each focal plane array having its own objective optical element secured in relation thereto comprises an individual camera comprising that focal plane array and in which the objective optical element is an integrated objective optic lens of the camera. In a more particular embodiment, The integrated objective optic lens of each individual camera is less than 2 millimeters in diameter.

### BRIEF DESCRIPTION OF THE DRAWING FIGURES

In order that the subject matter may be readily understood, embodiments are illustrated by way of examples in the accompanying drawings, in which:

FIG. 1 shows a schematic representation of an exemplary embodiment of a broad area surveillance system;

FIG. 2 shows a schematic representation of assembly of an exemplary Scheimpflug mosaic image;

FIG. 3 shows an exemplary Scheimpflug system configuration having eight FPAs behind four lenses;

FIG. 4 shows an exemplary Scheimpflug mosaic image representing a field of regard (FOR) for an exemplary Scheimpflug mosaic imaging system;

FIG. 5 shows assembly of an exemplary bugeye mosaic image from a plurality of individual images provided by a bugeye imaging system comprising four FPAs each having its own lens;

FIG. 6 is a perspective view showing conventional imaging using an objective lens;

FIG. 7 is a schematic representation of an exemplary positive-negative afocal objective optical element;

FIG. 8 is a schematic representation of an exemplary positive-positive afocal objective optical element;

FIG. 9 is a schematic representation of an exemplary InO;

FIG. 10 is a schematic representation of an exemplary InO arranged in combination with an exemplary afocal objective optical element;

FIG. 11 is a schematic representation of a first exemplary mosaic imaging system, according to an aspect of the present invention; and

FIG. 12 is a schematic representation of a second exemplary mosaic imaging system, according to an aspect of the present invention.

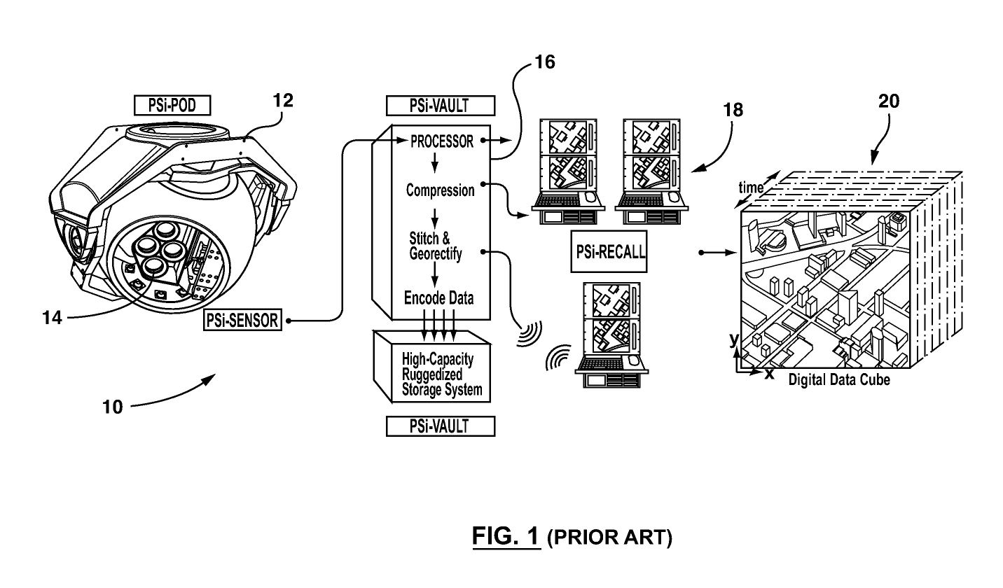

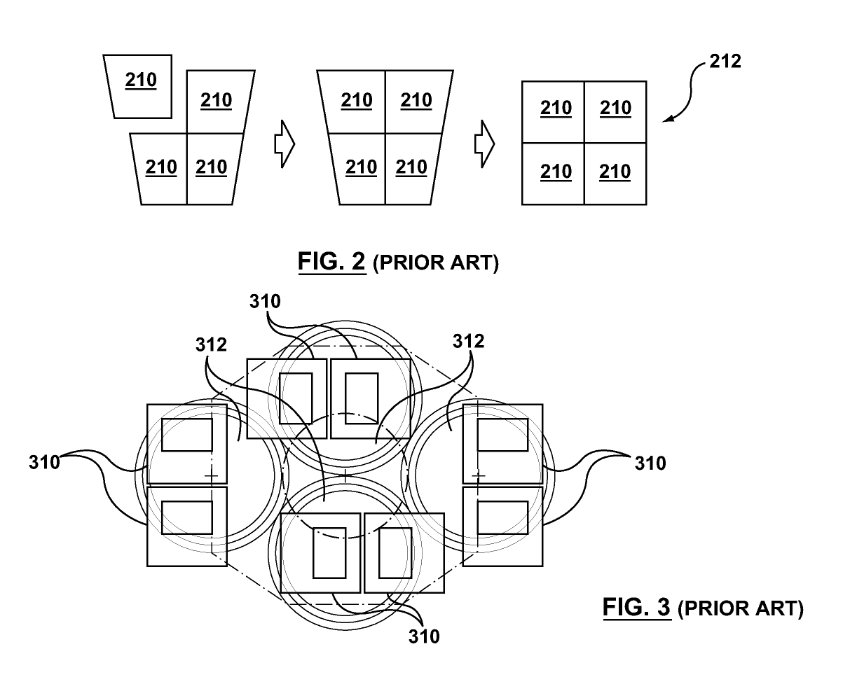

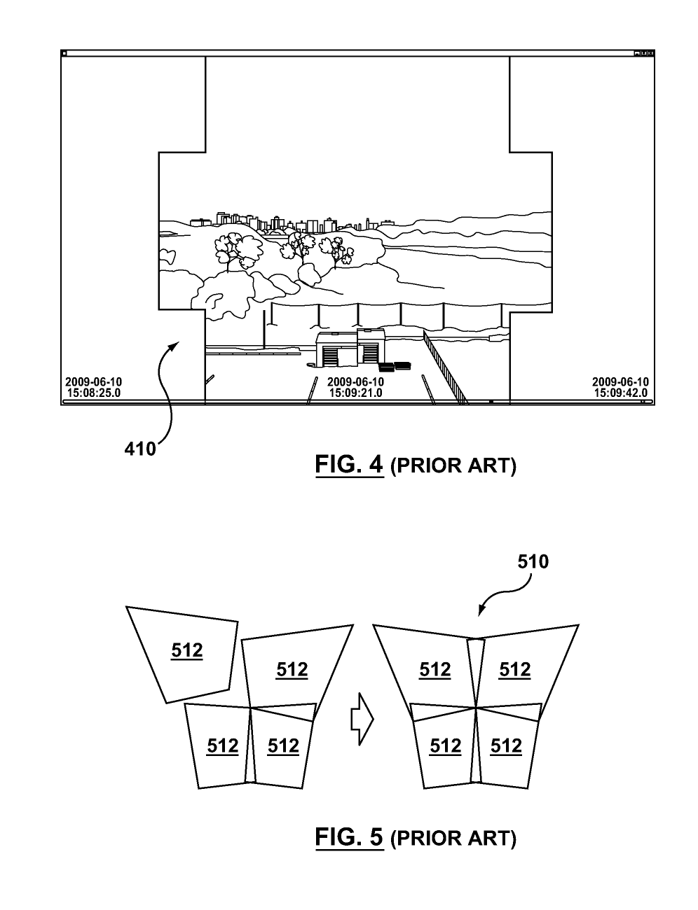

### DETAILED DESCRIPTION

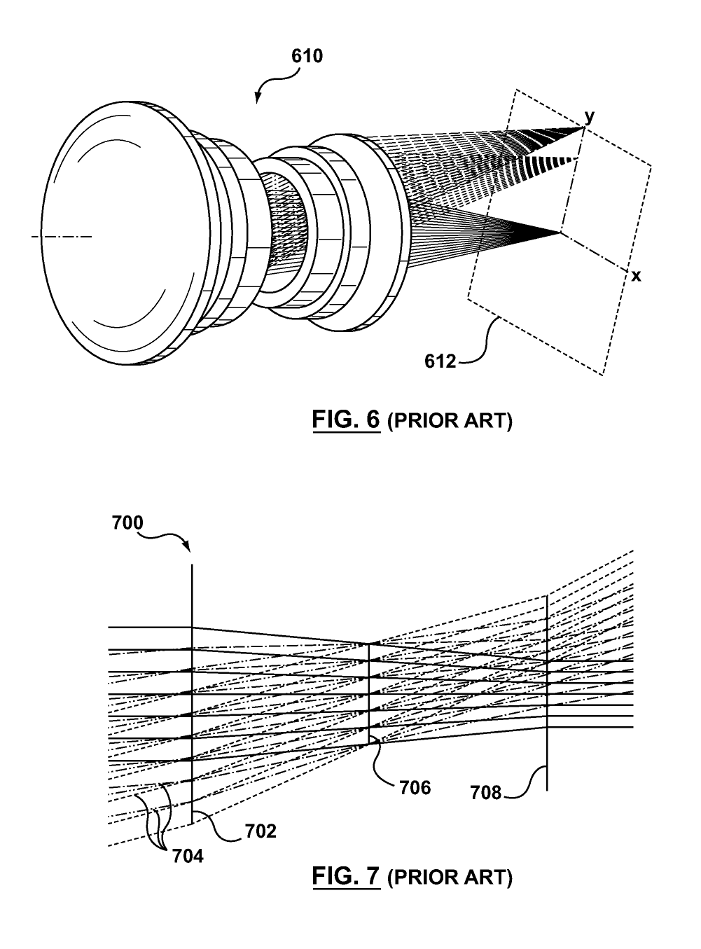

Referring now to FIG. 6, which depicts imaging using a conventional objective optical element 610 focusing onto a focal plane array (FPA) 612 located at the image plane of the objective optical element 610, it can be seen that the FPA 612 is constrained to lie in the plane in which the objective optical element 610 comes to a clear focus, or else the image will be unfocused. This requirement that the FPA 612 lie in the plane in which the objective optical element 610 comes to a clear focus constrains the position and orientation of the FPA 612 in three degrees of freedom: (a) the z position must be at the objective focus; (b) rotation about the y-axis must be correct so the image does not go out of focus along the x-axis; and (c) rotation about the x-axis must be correct so the image does not go out of focus along the y-axis. Similarly, there is a constraint as to registration between the image on the FPA and a particular region of object space (so that the FPA 612 receives an image of the correct portion of object space), which constrains the position and orientation of the FPA 612 in three further degrees of freedom: (d) rotation about the z-axis so the image is truly upright and not rotated; (e) translation along the x-axis to establish position in object space in that direction; and (f) translation along the y-axis for position establishment in object space. Thus, conventional objective imaging constrains the position and orientation of each and every FPA with respect to its corresponding objective lens in six degrees of freedom:

(1) Translation in x

(2) Translation in y

(3) Translation in z

(4) Rotation about x

(5) Rotation about y

(6) Rotation about z

All of these constraints must be satisfied in order for the FPA to be imaging the infinite conjugate in object space.

If, on the other hand, each FPA is already integrated with a chip-level integrated objective optic lens (InO), as is the case with conventionally known miniature cameras, then those FPAs will already be correctly focused to infinity, meaning that the constraints on translation in x, y and z are already accounted for. This is because in collimated space, within certain constraints, an optical element focusing from infinity to its FPA is insensitive to translations. FIG. 9 shows an InO 910 focusing collimated incoming light rays 908 onto an FPA 912 aligned with the image plane 914 of the InO 910. Typical InOs are on the order of 1-2 millimeters in diameter and operate with extremely short focal lengths. One suitable miniature camera having a chip-level integrated objective optic lens (InO) is the Aptina MT9V113, available from Aptina Incorporated, having an address at 3080 North 1^{st} Street, San Jose, Calif. 95134; other suitable miniature cameras can also be used.

Because in collimated space, within certain constraints, an optical element focusing from infinity to its FPA is insensitive to translations, by designing an appropriate afocal primary objective optical element, there can be provided a correctly tuned infinite conjugate from which the InO will then image. Two design examples of conventional afocal objective optical elements will now be described. In each case a stop is located in the physical center of the afocal objective optical element to provide for a shutter.

Referring now to FIG. 7, a conventional positive-negative afocal objective optical element is shown generally at 700. The positive-negative afocal objective optical element 700 comprises a positive lens 702, a stop 706, and a negative lens 708. The positive lens 702 condenses the incoming collimated light rays 704, which pass through the stop 706 and are then diverged back into collimated space by the negative lens 708, thus providing a positive-negative powered lens combination. The angular magnification is positive, such that the array of angles seen from behind the afocal objective optical element 700 is larger and with the same sign when compared to that seen without the afocal objective optical element 700, looking at the same extent of object. There is no intermediary plane at which an image is formed. The image is inverted relative to the object (i.e. top becomes bottom, etc.).

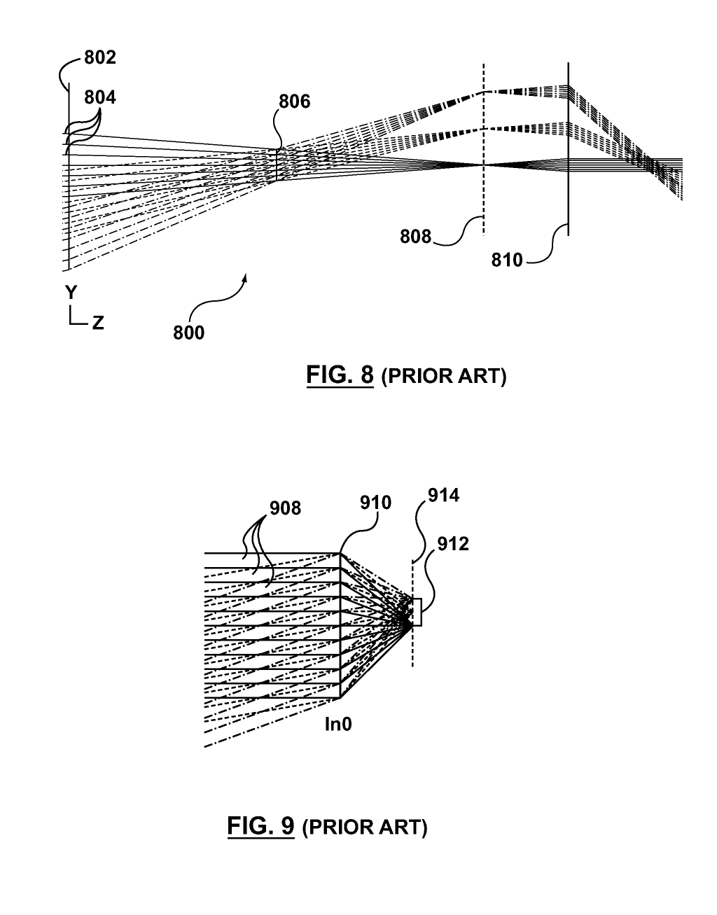

Now referring to FIG. 8, a conventional positive-positive afocal objective optical element is shown generally at 800. The positive-positive afocal objective optical element 800 comprises a first positive lens 802, a stop 806 and a second positive lens 810. The first positive lens 802 condenses the incoming collimated light rays 804, which pass through the stop 806 and focus to an intermediary image on an intermediary image plane 808, and then diverge to the second positive lens 810, which is of shorter focal length than the first positive lens 802. The second positive lens 810 recollimates the light rays 804, thus providing a positive-positive powered lens combination. The angular magnification is negative, such that the array of angles seen from behind the afocal objective optical element 800 is larger and with the opposite sign when compared to that seen without the afocal objective optical element 800, looking at the same extent of object.

Referring now to FIG. 11, an exemplary mosaic imaging system according to an aspect of the present invention is shown generally at 1110. The mosaic imaging system 1110 comprises a support structure 1112, which may be any suitable physical construct for carrying the relevant parts of the mosaic imaging system 1110. A plurality of individual focal plane arrays 1114 are secured to the support structure 1112, and each individual focal plane array 1114 has its own objective optical element 1116, such as a lens, secured in relation thereto so that the focal plane array 1114 and the objective optical element 1116 have a constant spatial relationship to one another. Each of the objective optical elements 1116 focuses its respective focal plane array 1114 to infinity, and each of the objective optical elements 1116 has its own entrance pupil 1122. The objective optical element 1116 may be secured directly to focal plane array 1114, or the focal plane array 1114 and the objective optical element 1116 may be secured to a common support structure. For example, as shown schematically in FIG. 11, each focal plane array 1114 may be part of a conventionally known miniature camera, such as a CCD (charge-coupled device) camera or a CMOS image sensor camera, with each objective optical element 1116 being a chip-level integrated objective optic lens (InO) also forming part of that miniature camera. In one embodiment, the diameter of each integrated objective optic lens is less than 2 millimeters.

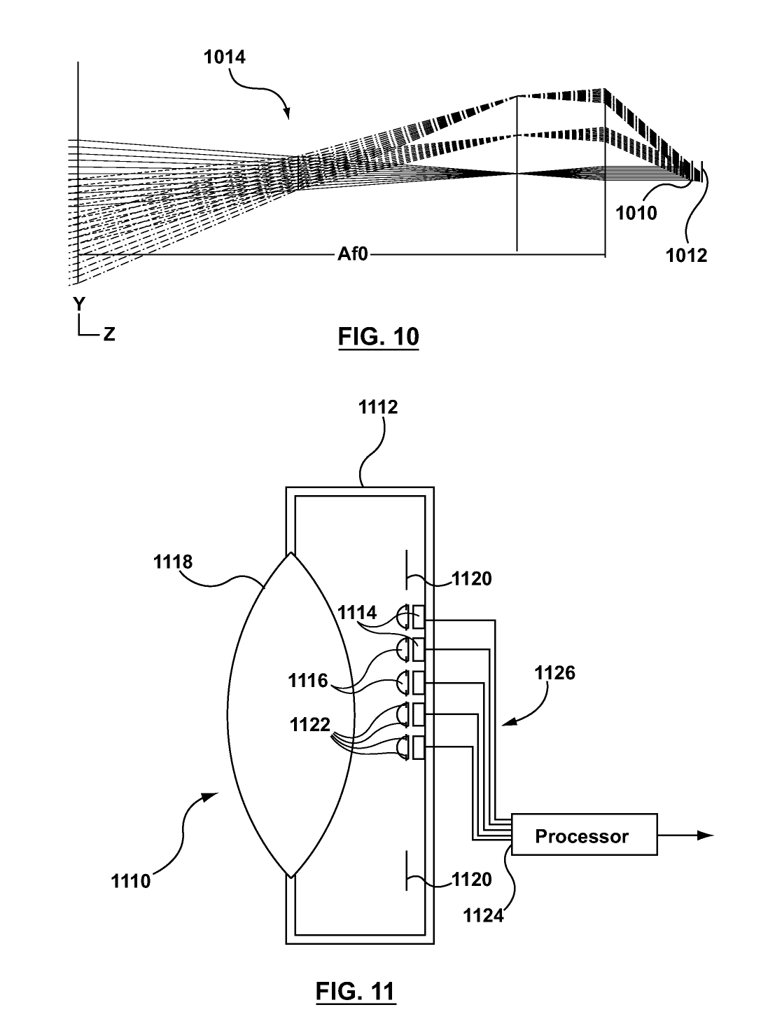

An afocal primary objective optical element 1118 is secured to the support structure 1112. In the illustrated embodiment, the primary objective optical element 1118 is shown as being a single lens; in other embodiments the primary objective optical element 1118 may comprise a plurality of lenses, and may include other optical elements such as mirrors, etc. depending on the application for which the mosaic imaging system is intended. The primary objective optical element 1118 may be, for example, a positive-negative lens combination as shown in FIG. 7, or a positive-positive lens combination as shown in FIG. 8. FIG. 10 shows a single InO 1010 and FPA 1012 positioned behind an afocal objective optical element 1014 comprising a positive-positive lens combination for illustrative purposes; in operation, a plurality of units each consisting of a single InO 1010 and associated FPA 1012 would be positioned behind the afocal objective optical element 1014. As can be seen in FIG. 11, because in this embodiment the entrance pupils 1122 of the of the objective optical elements (in this case InOs) 1116 are within the InOs 1116, the exit pupil 1120 of the afocal objective optical element 1118 must be larger than the entrance pupils 1122 of the InOs 1116 such that multiple such InO entrance pupils 1122 will fit within the exit pupil 1120 of the single afocal objective optical element 1118. Accordingly, as shown in FIG. 11, the primary objective optical element 1118 has an afocal exit pupil 1120 that subsumes the entrance pupils 1122 of each of the objective optical elements 1116 of the focal plane arrays 1114. The exit pupil 1120 and entrance pupils 1122 are illustrated schematically with lines in FIG. 11, as the exit pupil 1120 and entrance pupils 1122 are optical rather than physical features.

As can be seen in FIG. 11, the primary objective optical element 1118 is arranged relative to the objective optical elements 1116 of the focal plane arrays 1114 so as to maintain throughput and image integrity from object space of the primary objective optical element 1118 to each focal plane array 1114.

The focal plane arrays 1114 can provide their image data to a processor 1124 by any suitable coupling, such as by wired coupling 1126, by wireless communication, or any other suitable technique. This image data will comprise a set of individual images corresponding to the instantaneous fields of view (IFOVs) of each focal plane array 1114, and the processor 1124 can then combine these individual images into a larger image representing the field of regard of the mosaic imaging system 1110 using known imaging techniques. The resulting larger image can then be stored and analyzed.

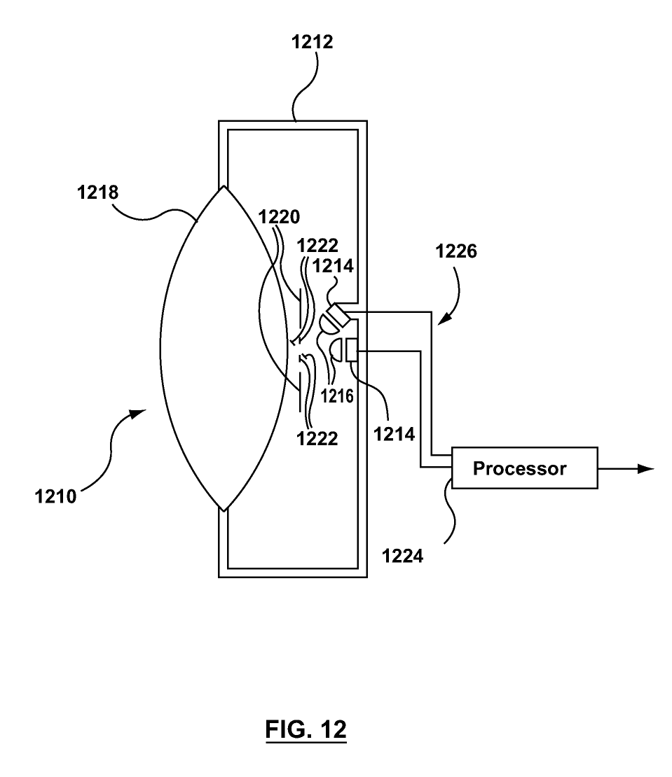

Referring now to FIG. 12, an alternative exemplary mosaic imaging system according to an aspect of the present invention is shown generally at 1210, and which is similar in construction to the mosaic imaging system 1110. Accordingly, identical reference numerals are used to identify corresponding components, but beginning with “12” instead of “11”. Thus, the support structure is denoted by the reference numeral 1212, the individual focal plane arrays are denoted by the reference numeral 1214, and so on. As with FIG. 11, in FIG. 12 the exit pupil 1220 and entrance pupils 1222 are illustrated schematically with lines because they are optical rather than physical features.

In the mosaic imaging system 1210, the InOs 1216 are configured to project their entrance pupils 1222 in front of the respective InO 1216. In such a case, in order for the afocal exit pupil of the primary objective optical element to subsume the entrance pupils of the InOs, the exit pupil need only be as large as the entrance pupil of one InO (or the largest InO if they are of different sizes). As shown in FIG. 12, the exit pupil 1220 of the afocal objective optical element 1218 is the same size as the largest InO entrance pupil 1222, with the entrance pupils 1222 of multiple InO's occupying the same region of 3-D space. While only two focal plane arrays 1214 with InOs 1216 are shown in FIG. 12 for ease of illustration, a configuration such as that shown in FIG. 12 may employ more than two focal plane arrays 1214 with InOs 1216.

In a mosaic imaging system (such as the mosaic imaging systems 1110, 1210) according to an aspect of the present invention, because each individual focal plane array has its own objective optical element focusing from infinity to that focal plane array, each unit consisting of a focal plane array and integrated objective optical element will be insensitive to translations. Accordingly, as long as a focal plane array is positioned to have focused thereon the desired part of object space (i.e. the focal plane array has the correct location in image space), any two or more of the individual focal plane arrays can occupy different geometric planes. In other words, there is no single image plane on which all of the focal plane arrays must be arranged. For example, as shown in FIG. 12, the focal plane arrays 1214 occupy different geometric planes.

Selection of the afocal primary objective optical element, such as optical elements 1118, 1218, and relative arrangement of the afocal primary objective optical element, such as optical elements 1118, 1218, and the individual focal plane arrays with attached objective optical elements, such as FPAs 1114, 1214 and their respective objective optical elements 1116, 1216, is within the capability of one skilled in the art once informed by the herein disclosure. For example, where each focal plane array/objective optical element pair is a particular type of commercially available miniature camera, such as a CCD (charge-coupled device) camera or a CMOS image sensor camera, the number and positioning of these miniature cameras, as well as the design and positioning of the afocal primary objective optical element, can be selected to produce an imaging system having the desired characteristics.

Programming of processors, such as the exemplary processors 1124, 1224, to receive and process data representing individual images corresponding to the instantaneous fields of view (IFOVs) of each focal plane array, such as the focal plane arrays 1114, 1214, and combine these individual images into a larger mosaic image representing the field of regard of the mosaic imaging system, such as the exemplary systems 1110, 1210, is within the capability of those skilled in the art, once informed by the herein disclosure.

One or more currently preferred embodiments have been described by way of example. It will be apparent to persons skilled in the art that a number of variations and modifications can be made without departing from the scope of the invention as defined in the claims.

What is claimed is:

1. A mosaic imaging system, comprising:
a support structure;
a plurality of individual focal plane arrays secured to the support structure;
each focal plane array having its own objective optical element secured in relation thereto so that the focal plane array and the objective optical element have a constant spatial relationship to one another, with the objective optical element focusing the focal plane array to infinity;
an afocal primary objective optical element secured to the support structure;
the primary objective optical element having an exit pupil subsuming entrance pupils of each of the objective optical elements of the focal plane arrays;
the primary objective optical element arranged relative to the objective optical elements of the focal plane arrays to maintain throughput and image integrity from object space of the primary objective optical element to each focal plane array.

2. The mosaic imaging device of claim 1, wherein at least two of the individual focal plane arrays occupy different geometric planes.

3. The mosaic imaging system of claim 1, wherein each focal plane array having its own objective optical element secured in relation thereto comprises an individual camera comprising that focal plane array and in which the objective optical element is an integrated objective optic lens of that camera.

4. The mosaic imaging system of claim 1, wherein the integrated objective optic lens of each individual camera is less than 2 millimeters in diameter.
